(19) United States
(12) Patent Application Publication
(10) Pub. No.: US 2022/0063154 A1
(43) Pub. Date: Mar. 3, 2022

(54) CAVITY ANALYSIS METHOD, PROGRAM, CAVITY ANALYSIS DEVICE AND CASTING CONDITION DERIVATION METHOD

(71) Applicant: TOYOTA JIDOSHA KABUSHIKI KAISHA, Toyota-shi (JP)

(72) Inventor: Masakura TEJIMA, Toyota-shi (JP)

(73) Assignee: TOYOTA JIDOSHA KABUSHIKI KAISHA, Toyota-shi (JP)

(21) Appl. No.: 17/333,861

(22) Filed: May 28, 2021

(30) Foreign Application Priority Data
Sep. 2, 2020 (JP) 2020-147735

(51) Int. Cl. B29C 44/42; B29B 13/02; B22D 27/11

(52) U.S. Cl. CPC B29C 44/424; B22D 27/11; B29B 13/02

(57) ABSTRACT

The following formula represents a gas cavity distribution of a diameter d of gas cavities in a casting product and the number n of gas cavities, where n is greater than or equal to zero, in vacuum die-casting. A constant A is a function of a flow velocity v of a molten material injected into the cavity at a gate. A constant B is a function of a residual gas amount m in the cavity:

In(n)=−Bd+In(A)

For cavity analysis, casting conditions including the flow velocity v and the residual gas amount m are input to a computer, and the computer is caused to calculate a gas cavity distribution according to the formula.

### CROSS-REFERENCE TO RELATED APPLICATION

This application claims priority to Japanese Patent Application No. 2020-147735 filed on Sep. 2, 2020, incorporated herein by reference in its entirety.

### BACKGROUND

### 1. Technical Field

The present disclosure relates to a cavity analysis method, a program, a cavity analysis device and a casting condition derivation method in vacuum die-casting.

### 2. Description of Related Art

Like other die-casting and other casting methods, also in vacuum die-casting, cavities may occur in casting products. The cavities include shrinkage cavities that occur mainly in the central part of the casting product and gas cavities that occur mainly in the outer edge part of the casting product.

In die-casting including vacuum die-casting, a gate ejects a molten material into a cavity. The molten material replaces gas in the cavity while forming a turbulent flow. Gas cavities occur when the molten material traps gas. Japanese Unexamined Patent Application Publication No. 2010-131607 (JP 2010-131607 A) discloses a method of predicting positions of gas cavities based on the molten material pressure in die-casting.

### SUMMARY

An object of one aspect of the present disclosure is to provide a method of predicting a distribution of the sizes of gas cavities in a casting product and the number of gas cavities in vacuum die-casting.

An object of another aspect of the present disclosure is to provide a method of deriving casting conditions for vacuum die-casting. The method is suitable for making the distribution of the sizes of gas cavities in a casting product and the number of gas cavities a desired distribution.

In a cavity analysis method according to one aspect of the present disclosure, the following formula represents a regression line of a distribution of a diameter d of gas cavities in a casting product and the number n of gas cavities (n≥0) in vacuum die-casting (hereinafter referred to as a gas cavity distribution), which is specific to a shape and dimensions of die cavities.

In(n)=−Bd+In(A)

A constant A is a function of a flow velocity v of a molten material injected into the cavity at a gate, and

a constant B is a function of the mass of the residual gas in the cavity (hereinafter referred to as a residual gas amount m).

The cavity analysis method includes the following:

inputting casting conditions including the flow velocity v and the residual gas amount m to a computer; and

causing the computer to calculate a prediction of characteristics of the gas cavity distribution according to the above formula.

A program according to one aspect of the present disclosure causes a computer to receive an input of casting conditions including the flow velocity v and the residual gas amount m, and calculate a prediction of characteristics of the gas cavity distribution according to the above formula.

A cavity analysis device according to one aspect of the present disclosure receives an input of casting conditions including the flow velocity v and the residual gas amount m, and calculates a prediction of characteristics of the gas cavity distribution according to the above formula.

A casting condition derivation method according to one aspect of the present disclosure includes the following:

inputting conditions required for the gas cavity distribution to a computer when casting conditions including the flow velocity v and the residual gas amount m are derived; and

causing the computer to calculate the casting conditions according to the formula of the gas cavity distribution.

According to one aspect of the present disclosure, it is possible to provide a method of predicting a distribution of the sizes of gas cavities in a casting product and the number of gas cavities in vacuum die-casting.

According to another aspect of the present disclosure, it is possible to provide a method of deriving casting conditions for vacuum die-casting. Such a method is suitable for making the distribution of the sizes of gas cavities in a casting product and the number of gas cavities a desired distribution.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows injection (upper part) of a molten material and cavities (lower part);

FIG. 2 is a histogram with the sizes of gas cavities as classes and the number of gas cavities as a frequency;

FIG. 3 shows a regression line H between the sizes of gas cavities and a logarithm of the number of gas cavities;

FIG. 4 shows a regression line Q between a degree of vacuum p of cavities and a constant B to the power of minus two;

FIG. 5 shows a guide straight line G of a distribution of the sizes of gas cavities and the number of gas cavities; and

FIG. 6 is a flow of casting condition derivation.

### DETAILED DESCRIPTION OF EMBODIMENTS

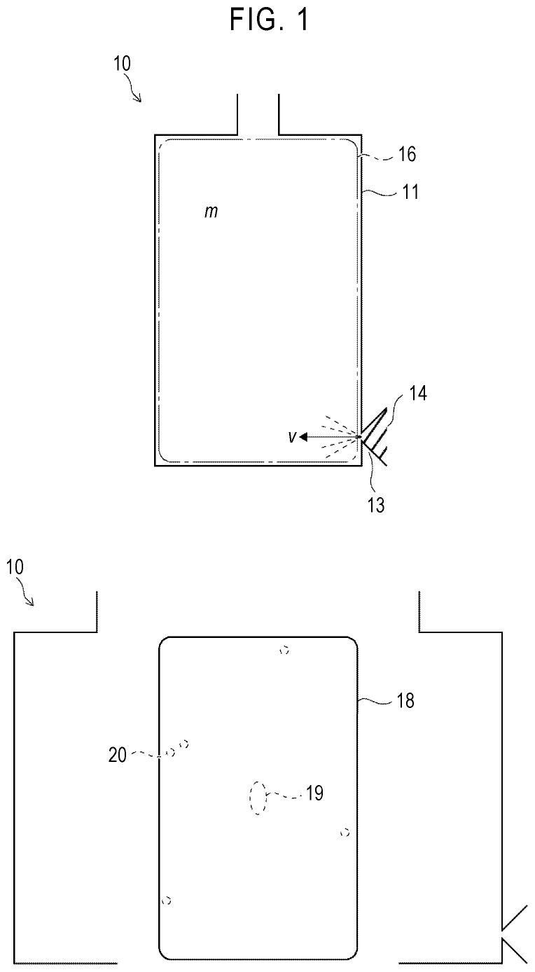

The upper part in FIG. 1 shows one aspect of injection of a molten material in vacuum die-casting (hereinafter simply referred to as die-casting). Before casting, a cavity 11 is filled with a residual gas 16. The inside of the cavity 11 is depressurized. The cavity 11 has a degree of vacuum p (torr) that is arbitrarily determined. The mass of the residual gas 16 is set as a residual gas amount in.

As shown in the upper part in FIG. 1, a gate 13 injects a molten material 14 into the cavity 11 of a die 10. The molten material 14 is ejected into the cavity 11 at a flow velocity v. The molten material 14 is formed of an aluminum alloy or other metals. A part of the ejected molten material 14 becomes a mist-like turbulent flow. A part of the molten material 14 becomes a laminar flow and flows on the inner wall of the cavity 11.

The lower part in FIG. 1 shows one aspect of a casting product 18 in die-casting. In this example, shrinkage cavities 19 and gas cavities 20 are formed in the casting product 18. The shrinkage cavities 19 are particularly likely to occur inside the casting product 18. The shrinkage cavities 19 have a vacuum. The gas cavities 20 are particularly likely to occur on the outer edge of the casting product. Some of the residual gas 16 is caught in the gas cavity 20. In one aspect, the gas cavity 20 is a fine gas pore (gas porosity).

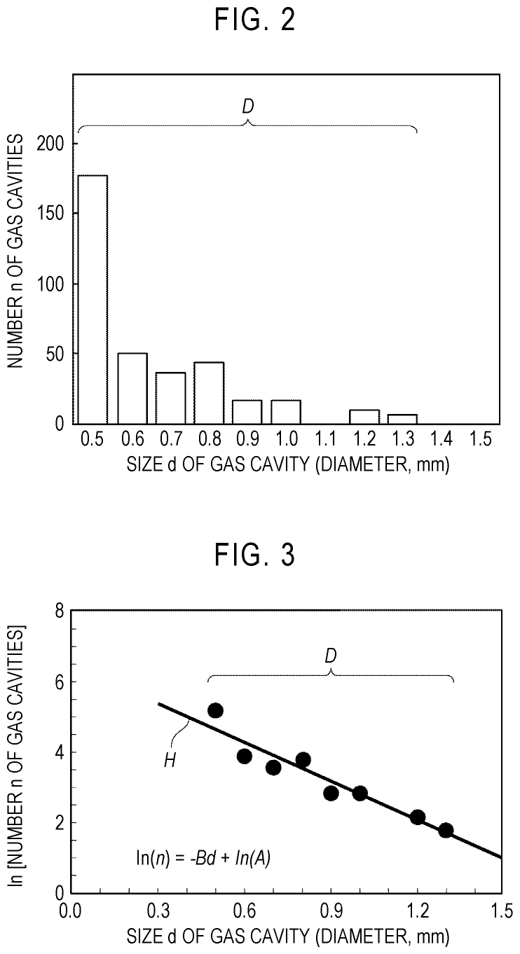

FIG. 2 is a histogram showing the size of the gas cavities in the casting product, that is, with the diameter d (mm) as a class and the number n of gas cavities as a frequency. Hereinafter, the distribution of the diameter d of gas cavities and the number n of gas cavities may be referred to as a gas cavity distribution D.

FIG. 3 shows a regression line H of the gas cavity distribution D shown in FIG. 2. The number n of gas cavities is logarithmic. The regression line H represented by the following formula is determined from the gas cavity distribution D.

In(n)=−Bd+In(A)

The regression line H shown in FIG. 3 is specific to the shape and dimensions of the die cavity. The intercept of the regression line H is In(A). The regression coefficient of the regression line H is −B. The constant A and the constant B are determined by the regression analysis from the data set of the gas cavity distribution D determined by experimentally die-casting with a sample die. Hereinafter, unless otherwise specified, the term of the data set refers to a data set of the gas cavity distribution D.

In the regression line H shown in FIG. 3, the constant A is a function of the flow velocity v of the molten material at the gate. The constant A is a positive number. The function A=A(v) is specific to the shape and dimensions of the die cavity. In one aspect, the correlation between the constant A and the flow velocity v is subjected to regression analysis in advance. In one aspect, the constant A is represented by a linear function of the flow velocity v. In one aspect, the constant A is proportional to the flow velocity v. In one aspect, the flow velocity v is a function of the residual gas amount m.

In the regression line H shown in FIG. 3, the constant B is a function of the residual gas amount m of the molten material at the gate. The constant B is a positive number. The function B=B(m) is specific to the shape and dimensions of the die cavity. In one aspect, the correlation between the constant B and the residual gas amount m is subjected to regression analysis in advance.

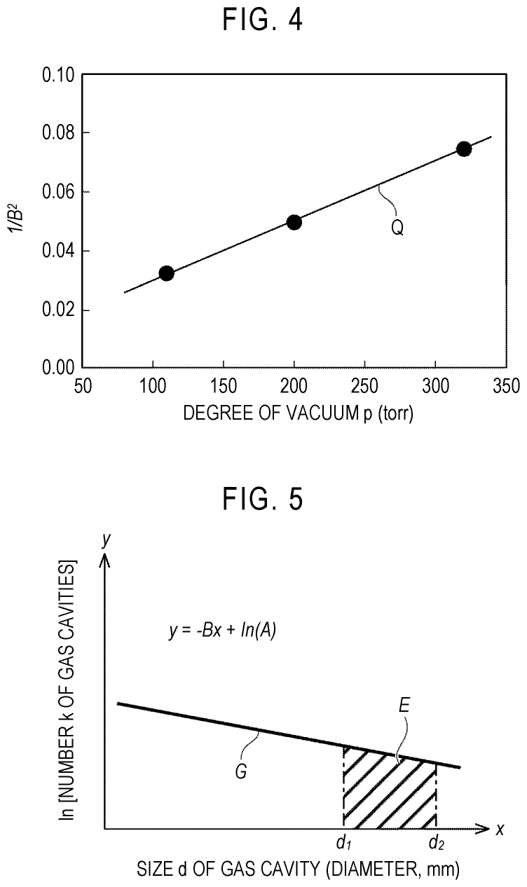

FIG. 4 shows a regression line Q of the distribution of the degree of vacuum p of the cavity and the constant B. The vertical axis represents the constant B to the power of minus two. The degree of vacuum p is a measured value of the degree of vacuum of the die cavity (measured vacuum value of die cavity, torr). The fact that the regression line Q can be determined from the degree of vacuum p and the constant B indicates that the constant B is proportional to the residual gas amount m.

FIG. 5 shows a guide straight line G. In one aspect, the same straight line as the regression line H shown in FIG. 3 is treated as a guide straight line G for cavity analysis. Based on the guide straight line G, a gas cavity distribution in the casting product is predicted. x according to the guide straight line G corresponds to the diameter d according to the regression line H shown in FIG. 3. y according to the guide straight line G corresponds to In(n) related to the regression line H shown in FIG. 3.

In FIG. 5, a region E represents the distribution of gas cavities larger than the reference size. The diameter d₁ represents the reference size. The reference size is selected based on the performance required for the casting product. In one aspect, the reference size is a value of 0.3 mm or more and 1.5 mm or less. In one aspect, the reference size is any of 0.4, 0.5, 0.6, 0.7, 0.8, 0.9, 1.0, 1.2, 1.3 and 1.4 mm.

In one aspect shown in FIG. 5, the diameter d₂ is a value that is smaller than the x-intercept and larger than d₁. In another aspect, the diameter d₂ is an x-intercept. The diameter d₂ is arbitrarily set. The number k of gas cavities included in the region E is represented as follows. A probability of occurrence of gas cavities larger than the reference size is determined from the number k.

k=∫_{d}_{₁}^{d}^{₂}Ae^{-Bx}dx

In one aspect shown in FIG. 5, when the guide straight line G is discretely treated, the number k of gas cavities is determined according to the following formula.

k=ΣⱼAe^{-bxj}

xⱼ represents a diameter larger than a reference size.

In another aspect, conditions for the desired gas cavity distribution are determined first. The constant A and the constant B are calculated backward based on the conditions for the gas cavity distribution. In addition, casting conditions including the flow velocity v of the molten material and the residual gas amount m are derived by back calculation.

Each of the aspects is performed as computer aided engineering (CAE). In one aspect, the embodiment is performed when a program is executed by a computer. In one aspect, the operation of a computer that executes a program is performed by a plurality of devices connected via a network. In one aspect, a central processing unit (CPU) performs some or all of processes of a computer that executes a program. In one aspect, another device performs some of processes of a computer that executes a program.

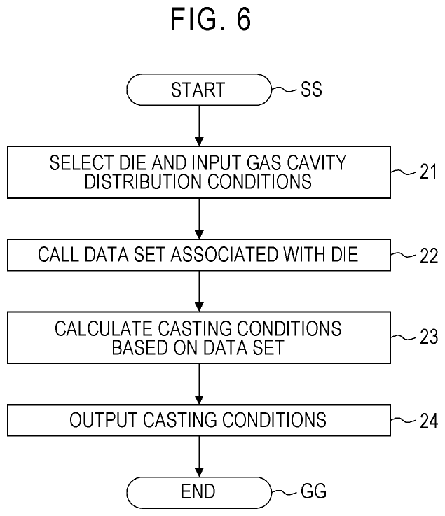

FIG. 6 shows a flow in which a computer automatically derives casting conditions. In Step 21, an operator or another device selects a die from which casting conditions are to be derived from among candidates therefor. In addition, the operator or other device determines conditions required for the gas cavity distribution. The operator or other device inputs the conditions to the computer. In one aspect, the other device is connected to the computer via a network. In one aspect, the other device is a die-cast device. The die-cast device selects a die provided therein as the die for which the casting conditions are to be derived and sends the information to the computer.

In one aspect, the condition required for the gas cavity distribution is that the number k of gas cavities included in the region E shown in FIG. 5 be a desired number or a smaller value. In one aspect, the desired number is 0. In another aspect, the condition required for the gas cavity distribution is that a probability of occurrence of gas cavities obtained from the number k of gas cavities included in the region E shown in FIG. 5 be a desired value or a smaller value. In one aspect, the desired value is 0%.

In Step 22 shown in FIG. 6, the computer calls the data set of the gas cavity distribution D shown in FIG. 3 from a database. The data set to recall is a data set associated with the shape and dimensions of the selected die. In one aspect, the database is connected to the computer via a network. In another aspect, the computer has the database.

The data set is created in advance by performing experimental casting on each sample die which is candidate for selection. In an example, respective data items are determined by measuring the values of the number n of gas cavities and the diameter d of the gas cavities shown in FIG. 2 while changing the flow velocity v and the residual gas amount m of the molten material shown in FIG. 1. In one aspect, the number n of gas cavities and the diameter d of the gas cavities are measured by observing a cross section of the casting product under a microscope. In another aspect, the number n and the diameter d are measured by image analysis with X-rays that pass through the casting product. In another aspect, an X-ray CT device is used for measurement.

Before Step 22 shown in FIG. 6 is performed, the database may record the regression line H or a set of the constant A and the constant B in advance. The computer may call the regression line H or the set of the constant A and the constant B in place of the data set. The regression line H and the set of the constant A and the constant B are associated with the shape and dimensions of the die.

In Step 23 shown in FIG. 6, the computer obtains the regression line H shown in FIG. 3 from the data set. The computer back-calculates casting conditions including the flow velocity v of the molten material and the residual gas amount m based on the conditions required for the gas cavity distribution and the regression line H. In one aspect, the calculated casting conditions are stored in a storage device. In one aspect, the storage device is connected to the computer via a network. In another aspect, the computer includes the storage device.

In Step 24 shown in FIG. 6, the computer outputs the calculated casting conditions. An output destination is any of a display, a printer and other devices. In one aspect, these are connected via a network. In one aspect, the other device is a die-cast device. The die-cast device performs die-casting with the same die as the die previously selected according to the received casting conditions.

In one aspect, an analysis device performs the process of automatically deriving casting conditions. In one aspect, the analysis device includes the computer. In one aspect, the analysis device includes a program that causes a computer to perform the process.

### REFERENCE EXAMPLE 1

In Japanese Unexamined Patent Application Publication No. 63-026252 (JP 63-026252 A), a graph showing the relationship between the sizes of cavities and the number of cavities was created for each casting condition from the die-casting prototype. Those skilled in the art derived casting conditions by comparing them. The casting condition was related to whether secondary pressurization was performed. On the other hand, in the method in the embodiment, the distribution of the sizes of gas cavities and the number of gas cavities was associated with the casting conditions including the flow velocity and the residual gas amount of the molten material. After die-casting was performed under casting conditions determined by the method in the embodiment, secondary pressurization may be performed with reference to JP 63-026252 A or based on other known techniques. In another aspect, no secondary pressurization was performed.

### REFERENCE EXAMPLE 2

In Japanese Unexamined Patent Application Publication No. 2003-112254 (JP 2003-112254 A), a table showing the relationship between the number of cavities with a reference size of 0.2 mm or more and the casting conditions was created from the prototype of casting with a sand mold. Those skilled in the art evaluated this and derived conditions for hot isostatic pressing. Hot isostatic pressing is a method of pressurizing a casting product with a liquid after casting. On the other hand, the method of the embodiment was used for deriving conditions for the casting itself. The occurrence of gas cavities was minimized when die-casting was performed under casting conditions determined by the method in the embodiment, and also shrinkage cavities may be removed by performing hot isostatic pressing with reference to JP 2003-112254 A or based on other known techniques. In another aspect, hot isostatic pressing was not performed.

### REFERENCE EXAMPLE 3

In Japanese Unexamined Patent Application Publication No. 2009-045659 (JP 2009-045659 A), a fractal dimension was calculated from a linear approximation of logarithmic plots of the cross-sectional area of void defects and the number of cavities with a cross-sectional area larger than thereof from a die-casting prototype. Those skilled in the art determined whether void defects were shrinkage cavities or gas defects, that is, gas cavities, based on a threshold value for the fractal dimension. On the other hand, in the method of the embodiment, the distribution of the sizes of gas cavities and the number of gas cavities was associated with the casting conditions including the flow velocity and the residual gas amount of the molten material. In obtaining the regression line H in FIG. 3, the number of gas cavities may be measured after distinguishing gas cavities in the casting product from shrinkage cavities using the method in JP 2009-045659 A or based on other known techniques. In another aspect, the method in JP 2009-045659 A was not used to distinguish between gas cavities and shrinkage cavities.

What is claimed is:

1. A cavity analysis method in which the following formula represents a regression line of a gas cavity distribution of a diameter d of gas cavities in a casting product and the number n of gas cavities, where n is greater than or equal to zero, in vacuum die-casting, which is specific to a shape and dimensions of die cavities:
In(n)=−Bd+In(A)
a constant A is a function of a flow velocity v of a molten material injected into the cavity at a gate, and
a constant B is a function of a residual gas amount m that is a mass of the residual gas in the cavity,
the method comprising:
inputting casting conditions including the flow velocity v and the residual gas amount m to a computer; and
causing the computer to calculate a prediction of characteristics of the gas cavity distribution according to the above formula.

2. The cavity analysis method according to claim 1, further comprising
inputting a reference size of the diameter d of the gas cavities to the computer,
wherein the prediction of characteristics of the gas cavity distribution includes a prediction of the number of gas cavities having a diameter equal to or larger than the reference size.

3. A program in which the following formula represents a regression line of a gas cavity distribution of a diameter d of gas cavities in a casting product and the number n of gas cavities, where n is greater than or equal to zero, in vacuum die-casting, which is specific to a shape and dimensions of die cavities:
In(n)=−Bd+In(A)
a constant A being a function of a flow velocity v of a molten material injected into the cavity at a gate, and
a constant B being a function of a residual gas amount m that is a mass of the residual gas in the cavity,
the program causing a computer to:
receive an input of casting conditions including the flow velocity v and the residual gas amount m; and
calculate a prediction of characteristics of the gas cavity distribution according to the above formula.

4. A cavity analysis device in which the following formula represents a regression line of a gas cavity distribution of a diameter d of gas cavities in a casting product and the number n of gas cavities, where n is greater than or equal to zero, in vacuum die-casting, which is specific to a shape and dimensions of die cavities:
In(n)=−Bd+In(A)
a constant A being a function of a flow velocity v of a molten material injected into the cavity at a gate, and
a constant B being a function of a residual gas amount m that is a mass of the residual gas in the cavity,
wherein the cavity analysis device receives an input of casting conditions including the flow velocity v and the residual gas amount m, and
calculates a prediction of characteristics of the gas cavity distribution according to the above formula.

5. A casting condition derivation method in which the following formula represents a regression line of a gas cavity distribution of a diameter d of gas cavities in a casting product and the number n of gas cavities, where n is greater than or equal to zero, in vacuum die-casting, which is specific to a shape and dimensions of die cavities:
In(n)=−Bd+In(A)
a constant A being a function of a flow velocity v of a molten material injected into the cavity at a gate, and
a constant B being a function of a residual gas amount m that is a mass of the residual gas in the cavity,
the method comprising:
inputting conditions required for the gas cavity distribution to a computer when casting conditions including the flow velocity v and the residual gas amount m are derived; and
causing the computer to calculate the casting conditions according to the above formula.

6. The casting condition derivation method according to claim 5,
wherein the constant A and the constant B are a data set composed of values of the number n, the diameter d, the flow velocity v and the residual gas amount m, and are determined by performing regression analysis according to experimental die-casting with a sample die.

7. The casting condition derivation method according to claim 6,
wherein a set of the constant A and the constant B is stored in advance in a database, and
wherein the set is called from the database in order for the computer to use the above formula.
